(19) United States
(12) Patent Application Publication
(10) Pub. No.: US 2005/0065957 A1
(43) Pub. Date: Mar. 24, 2005

(54) Method for operating an Internet broadcasting station

(76) Inventor: Courtney Jones, Ft. Myers, FL (US)

Correspondence Address: HAHN LOESER & PARKS, LLP, One GOJO Plaza, Suite 300, AKRON, OH, 44311-1076, US

(21) Appl. No.: 10/664,407

(22) Filed: Sep. 19, 2003

(51) Int. Cl. G06F 17/00

(52) U.S. Cl. 707/102

(57) ABSTRACT

A method to generate revenue for an Internet broadcasting station is disclosed. The method includes providing audio programming content via the Internet broadcasting station over the Internet and providing an Internet search engine as part of the Internet broadcasting station such that a user of the Internet broadcasting station may search for web sites on the Internet without the audio programming content being interrupted. Also, the method includes paying a provider of the Internet broadcasting station a predetermined monetary amount from a sponsor of the Internet broadcasting station every time a user of the Internet broadcasting station goes to a web site of the sponsor using the Internet search engine.

### TECHNICAL FIELD

The present invention generally relates to methods for operating a media broadcasting station on a global information system. More particularly, embodiments of the present invention relate to methods for providing performance based advertising during an Internet media broadcast without interrupting the media broadcast, and providing a search engine in association therewith to allow a user to search content on the Internet, including sponsor sites.

### BACKGROUND OF THE INVENTION

Traditional broadcasting, such as radio or television, combines programming content (such as entertainment content or news content) with commercial advertising content. Programming content is periodically interrupted by commercial advertising content in units of, typically 30 to 60 seconds, to generate income. A user of the broadcast is forced to wait until the commercial advertising segment is finished before he is able to resume consumption of programming content.

On the Internet, search engines are used to find sources of information, media content, and advertisers. Advertisers pay the provider of the search engine to be found and are ranked according to bid, with the highest bid appearing first in a search list on the users PC (personal computer) screen. U.S. Pat. No. 6,269,361 describes such a bidding methodology for example.

Internet radio stations provide programming content and generate revenues from user subscriptions. Some Internet radio stations also broadcast through access providers, such as America Online (AOL) or the like, which requires a subscription. Thus, the users of the site pay a fee in order to access programming content of the radio station.

Public broadcasting, such as public radio or TV, and now in segments of Internet broadcasting, may depend upon corporate or foundation sponsors to generate income. The name of the sponsor associated with a certain programming content is often mentioned at the end of the broadcast of the sponsored program. Also, pleas for donations, in the form of on-air pledge drives, are made to users of public broadcasting to offset the cost of providing programming content. These pledge drives often interrupt programming content for extended periods of time.

Further limitations and disadvantages of conventional, traditional, and proposed approaches will become apparent to one of skill in the art, through comparison of such systems with the present invention as set forth in the remainder of the present application with reference to the drawings.

### BRIEF SUMMARY OF THE INVENTION

An embodiment of the present invention comprises a method to generate revenue for an Internet broadcast of digital entertainment. The method comprises providing audio or video programming content (such as music) via the Internet broadcasting station over the Internet. The method also includes providing an Internet search engine as part of the Internet broadcasting station such that a user of the Internet broadcasting station may search for web sites on the Internet without the programming content being interrupted. Also, a provider of the Internet broadcasting station is paid a predetermined monetary amount from a sponsor of the Internet radio station every time a user of the Internet radio station goes to a web site of the sponsor using the Internet search engine.

Another embodiment of the present invention comprises a method to generate revenue for an Internet radio station. The method includes setting up an account of monetary funds for each of a plurality of advertisers acting as sponsors of the Internet radio station, where each advertiser has a web site on the Internet. The method further includes having the plurality of advertisers place monetary bids for key search words that a search engine associated with the Internet radio station would use to find the web sites of the advertisers. The method assigns a rank value to each of the plurality of advertisers for each key search word bid on by the plurality of advertisers based on the bids. The method also includes paying a provider of the Internet radio station a bid amount from the accounts of the advertisers every time a user of the Internet radio station goes to a web site of the advertisers using the search engine with at least one of the key search words.

These and other advantages and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 illustrates an embodiment of a personal computer (PC) system displaying an Internet radio station view having a search engine sub-view on a screen of the PC system, in accordance with various aspects of the present invention.

FIG. 2 illustrates an embodiment of the PC system of FIG. 1 interfacing, via the Internet, to a server hosting the Internet radio station corresponding to the Internet radio station view of FIG. 1, in accordance with various aspects of the present invention.

FIG. 3 is a flowchart of a first embodiment of a method to generate revenue for the Internet radio station of FIG. 2, in accordance with various aspects of the present invention.

FIG. 4 is a flowchart of a second embodiment of a method to generate revenue for the Internet radio station of FIG. 2, in accordance with various aspects of the present invention.

### DETAILED DESCRIPTION OF THE INVENTION

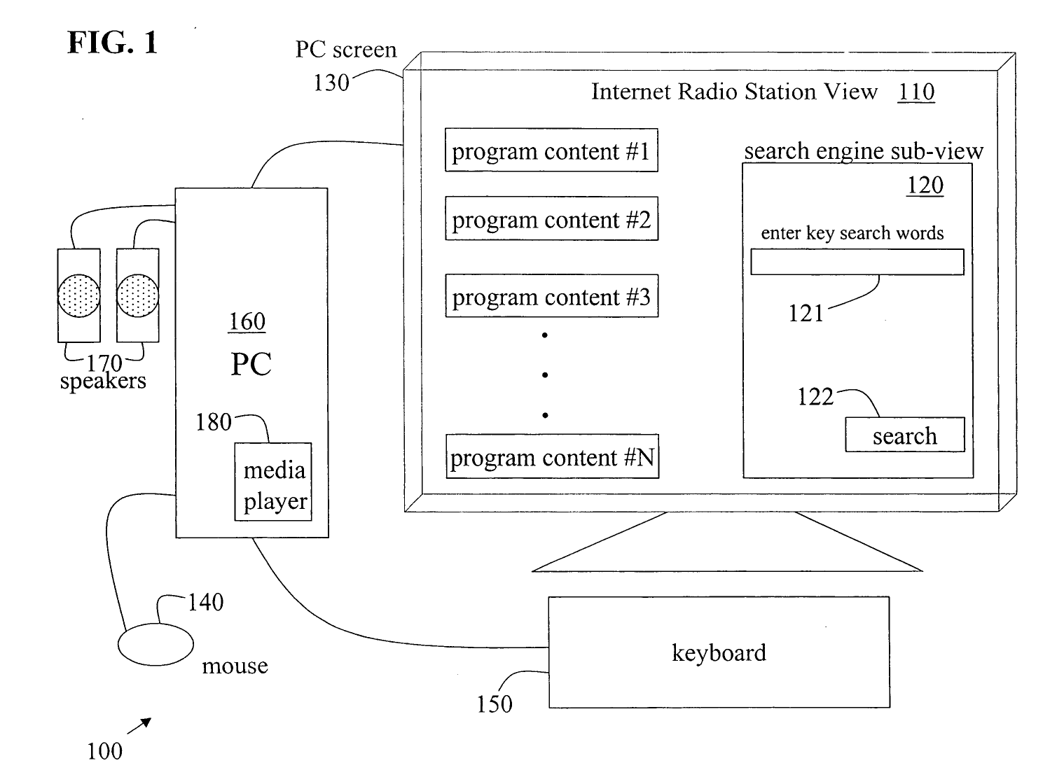

FIG. 1 illustrates an embodiment of a personal computer (PC) system 100 displaying an Internet broadcasting station view 110 having a search engine sub-view 120 on a display 130 of the PC system 100, in accordance with various aspects of the present invention. In the embodiment shown, the Internet broadcasting station may be an Internet radio station or can be any other suitable media broadcasting station.

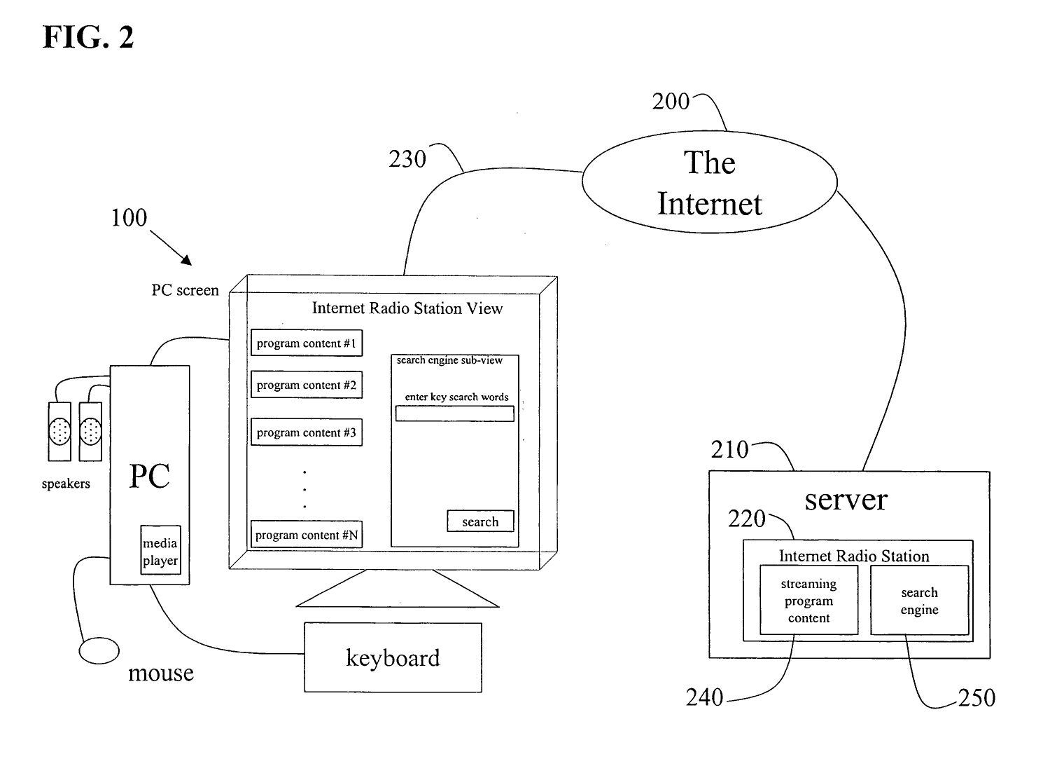

FIG. 2 illustrates an embodiment of the PC system 100 of FIG. 1 interfacing, via the Internet 200, to a server 210 hosting the Internet broadcasting station 220 corresponding to the Internet broadcasting station view 110 of FIG. 1, in accordance with various aspects of the present invention.

Referring to FIG. 1, in accordance with an embodiment of the present invention, the PC system 100 includes the screen 130, a mouse 140, a keyboard 150, a PC processing unit 160, and speakers 170. The PC screen 130, the mouse 140, the keyboard 150, and the speakers 170 each interface to the PC processing unit 160. The PC processing unit 160 also includes a media player module 180 capable of processing and playing digital streaming audio.

Referring to FIG. 2, a user of the PC system 100 may connect to the Internet 200 via traditional means such as a dial-up or high speed connection 230, for example, and go to a web site that comprises the Internet broadcasting station 220. The connection to the Internet 200 may be wired or wireless. In accordance with an embodiment of the present invention, the Internet broadcasting station 220 is hosted on a server 220 on the Internet 200. The Internet broadcasting station 220 may provide various streaming media program content 240 (such as, for example, music) and various display views (e.g., 110) to the PC system 100 via the established Internet connection. The Internet broadcasting station 220 also comprises the search engine 250 corresponding to the search engine sub-view 120.

A view 110 of the Internet broadcasting station 220 is displayed on the screen 130 of the PC system 100 to the user. In accordance with an embodiment of the present invention, a view 110 of the Internet broadcasting station 220 includes various program content choices #1-#N and a search engine sub-view 120. The search engine sub-view 120 includes a text entry area 121 to enter key search words, and a “search” icon 122 to click on to initiate a search. A user may use the mouse 140 or the keyboard 150 of the PC system 100 to select any of the program content choices #1-#N and to enter key search words in the text entry area 121 to perform a search on the Internet 200.

In use for an Internet radio embodiment for example, the various program content choices #1-#N may include, different choices of music types, different choices of individual songs, or different choices of any other type of audio programming such as, for example, a talk radio show. Other program content may also be provided. When a user clicks on a program content choice, streaming digital audio is provided from the Internet radio station 220 to the PC system 100 over the Internet connection 230 and is played by the media player module 180 of the PC system 100 through the speakers 170. In accordance with an embodiment of the present invention, the media player module 180 comprises a software module residing within the PC processing unit 160.

In accordance with an embodiment of the present invention, the user may use the search engine while listening to the streaming audio programming without interrupting the streaming audio. The user may proceed to input key search words into the search engine sub-view 120 using, for example, the keyboard 150 in order to look for certain web sites on the Internet. The web sites that a user may search for may include many different types of web sites that are hosted on the Internet, including web sites of advertisers who are sponsors of the Internet broadcasting station.

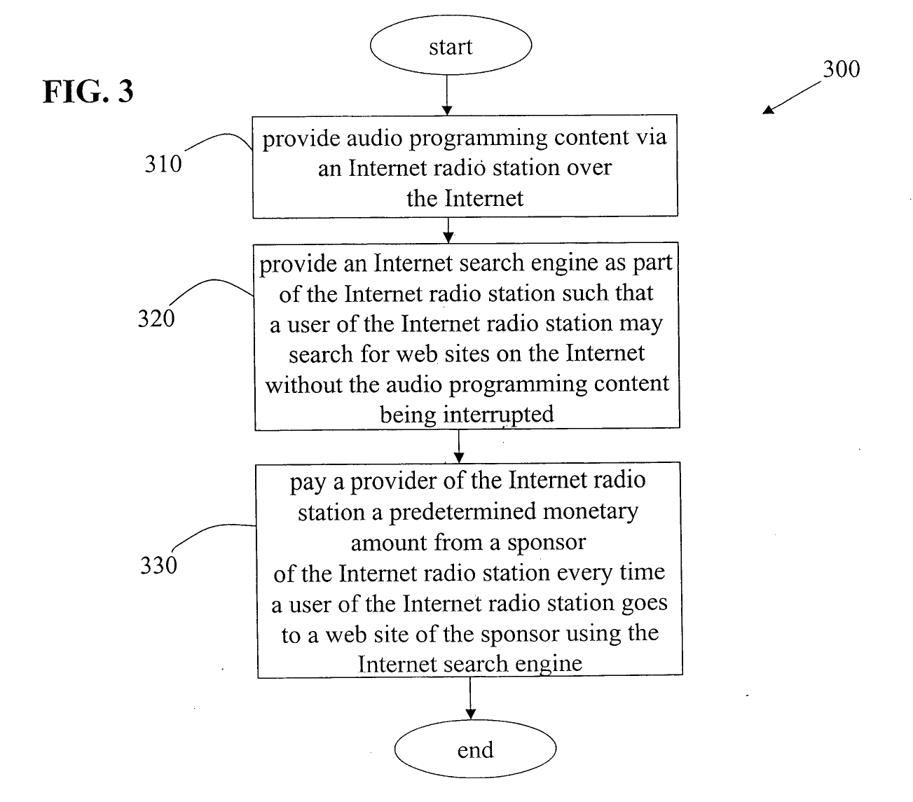

FIG. 3 is a flowchart of a first embodiment of a method 300 to generate revenue for the Internet radio station of FIG. 2, in accordance with various aspects of the present invention. In step 310, audio programming content is provided via an Internet broadcasting station over the Internet. In step 320, an Internet search engine is provided as part of the Internet broadcasting station such that a user of the Internet broadcasting station may search for web sites on the Internet without the audio programming content stream being interrupted. In step 330, a provider of the Internet broadcasting station is paid a predetermined monetary amount from a sponsor of the Internet broadcasting station every time a user of the Internet broadcasting station goes to a web site of the sponsor using the Internet search engine of the Internet broadcasting station.

For example, referring to FIG. 2, a user of the PC system 100 may access the Internet broadcasting station 220 and view the Internet broadcasting station view 110. The user may then click on program content #3 to initiate the reception of streaming audio, via the Internet 200, from the server 210 which is hosting the Internet broadcasting station 220. Once the user is comfortably listening to the program content #3 (which may be, for example, classical music), the user may then begin entering key search words into the search engine sub-view 120 to leisurely search the Internet 200 while listening to the streaming audio.

For example, a user of the PC system 100 enters the key search word “putter” in the search engine sub-view 120 and the search engine 250 produces a list of web sites of golf equipment retailers and displays these to the user on the PC screen 130. The user then clicks on the first golf equipment retailer listed and goes to their web site. As a result, the provider of the Internet broadcasting Station 220 is paid a predetermined monetary amount (e.g., $0.10) by the first golf equipment retailer in return for the “hit” via the Internet broadcasting station 220. In accordance with an embodiment of the present invention, the payment is made by automatically transferring the predetermined monetary amount from an account of the first golf equipment retailer to an account of the provider of the Internet broadcasting station 220. Other alternative methods of payment are also possible, in accordance with various embodiments of the present invention, such as, for example, keeping track of “hits” for a sponsor and sending a bill to the sponsor at the end of the month. As a result, uninterrupted, commercial-free listening is provided to the user, with the user having the option to search the Internet to find web sites of interest while, at the same time, helping to provide revenue for the Internet broadcasting station by searching.

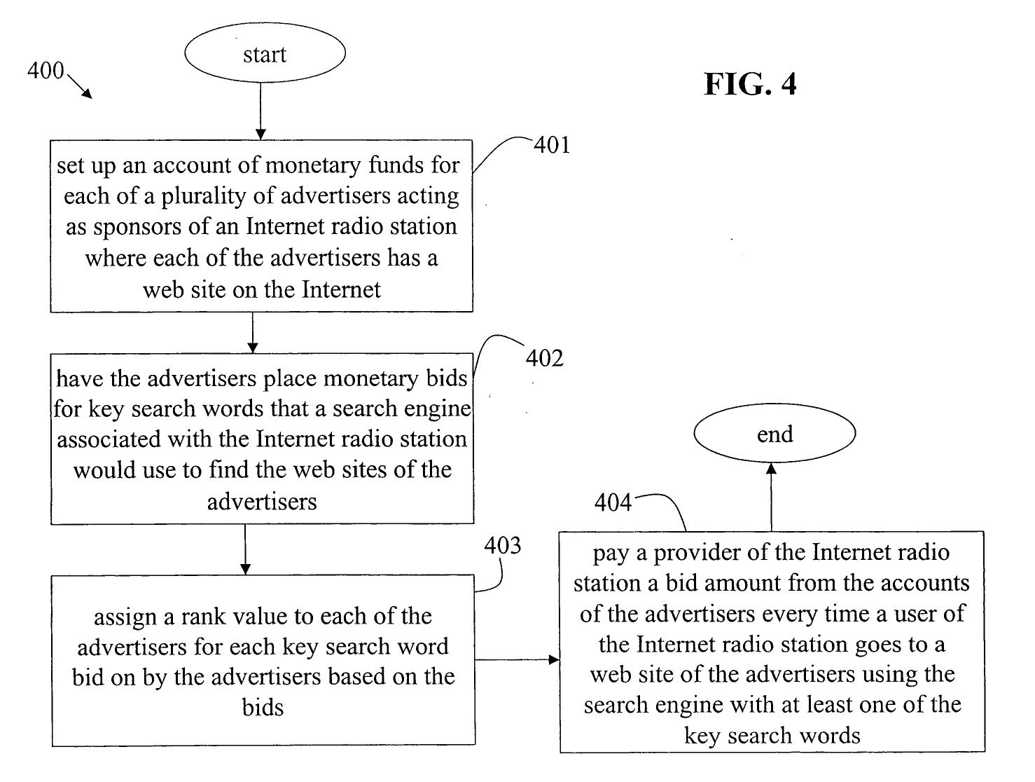

FIG. 4 is a flowchart of a second embodiment of a method 400 to generate revenue for the Internet broadcasting station 220 of FIG. 2, in accordance with various aspects of the present invention. In step 401, an account of monetary funds is set up for each of a plurality of advertisers acting as sponsors of an Internet broadcasting station where each of the advertisers has a web site on the Internet. In step 402, the advertisers place monetary bids for key search words that a search engine associated with the Internet broadcasting station would use to find the web sites of the advertisers. In step 403, a rank value is assigned to each of the advertisers for each key word bid on by the advertisers based on the bids. In step 404, a provider of the Internet broadcasting station is paid a bid amount from the accounts of the advertisers every time a user of the Internet broadcasting station goes to a web site of the advertisers using the search engine with at least one of the key search words.

For example, accounts of monetary funds each having $1000 may be set up for each of three golf equipment retailers having web sites on the Internet 200. Each of the golf equipment retailers place monetary bids for the key search word “putter”. The first retailer places a bid of $0.05 per web site hit, the second retailer places a bid of $0.10 per web site hit, and the third retailer places a bid of $0.12 per web site hit. As a result, the three golf equipment retailers will be ranked as:
rank=#1: third golf equipment retailer (bid the most)
rank=#2: second golf equipment retailer (bid the second most)
rank=#3: first golf equipment retailer (bid the least)

Therefore, when a user searches on the key search word “putter”, the three golf equipment retailers will appear in rank order (i.e., #1, #2, #3) in the search list. When a user goes to, for example, the second golf equipment retailer's web site, the bid amount (i.e., $0.10) is paid to the provider of the Internet broadcasting station from the account of the second golf equipment retailer. Again, other alternative methods of payment are possible, in accordance with various embodiments of the present invention.

Further, for use with an Internet radio station for example, a radio announcer for the Internet radio station 220 may periodically encourage the user to perform searches using the search engine 220 provided by the Internet radio station 220 in order to help generate revenue for the Internet radio station 220. In this way, the user is helping to keep the Internet radio station 220, which he presumably likes, on the air. In effect, the advertisers are “silently” sponsoring the Internet radio station 220.

The Internet broadcasting site also represents a distribution channel for media content that is typically targeted at a particular group of users. In an embodiment of the present invention, sponsors and key search words may be matched to the lifestyles or interests of users who listen to or watch a particular type of broadcasting station. For example, it may be known that, statistically, people who like to listen to classical music also like to play golf. Therefore, the search engine of a classical music Internet broadcasting station may be optimized for “the golfing lifestyle” by emphasizing certain key search words and, therefore, sponsors.

In accordance with an embodiment of the present invention, when an advertiser wants to become a sponsor of an Internet broadcasting station, the advertiser describes their web site and an editor reviews the description. The advertiser will also indicate which key words he will want to bid on and the editor will also review and compare the desired key search words to the description of the web site as well as to the actual web site itself. In this way, the editor is able to “qualify” the advertiser's web site for the Internet broadcasting station (i.e., make sure that the web site is legitimate, is the type of web site that the Internet broadcasting station is willing to accept as a sponsor, and that the key search words are appropriate for the web site).

It also is an aspect of the present invention to provide safeguards in use of the systems, to enhance the ability for sponsors to benefit from the advertising dollars spent. The search engine 250 of the Internet broadcasting station 220 may therefore include filters or other suitable devices to make sure a user is not just clicking on a web site to empty the associated account and, in general, to make sure the user traffic is qualified (e.g., is not from a competitor, etc.). In general, user traffic that comes from an Internet broadcasting station will tend to be very qualified (i.e., is likely to be legitimate user traffic).

In accordance with an embodiment of the present invention, the advertiser environment is intentionally limited such that a paying sponsor receives an enhanced position in the mind of the user. For example, when a user performs a search on a key search word, the search engine 250 may only display the top five advertisers based on willingness to pay (i.e., bids). The search engine 250 does not list, for example, twenty search results which may include non-paying advertisers.

In accordance with an alternative embodiment of the present invention, audio and/or video advertisements (i.e., commercials) may also be provided to users via the Internet broadcasting station. A user has the option to click on a directory of audio/video advertisements where a list of such commercials is displayed to the user. Again, similar to the search engine concept, the order that the advertisements appear on the list is based on how much each advertiser is willing to pay the Internet broadcasting provider per “hit” according to a bidding process. The user has the option to click on an available commercial advertisement in the list and listen to and/or view the commercial advertisement. In this way for example, the user has control of whether or not to interrupt the normal programming content, such as audio from an Internet radio station, to listen to a commercial.

Although examples of an Internet broadcasting station have related to Internet radio in cases, the Internet broadcasting station may instead be an Internet television station. Such a station would broadcast streaming audio and video over parts of the Internet that provide enough bandwidth to accommodate the audio and video programming. The Internet television station may operate in a similar manner, providing a search engine and/or a directory of commercial advertisements with sponsor payments to the Internet television station based on bids. Other media broadcasting sites may operate similarly.

For example, the main television programming content may be reduced in size and displayed to a user in a picture-in-picture (PIP) window when the user uses the search engine or chooses to view a commercial advertisement. The main display area of the screen may then be used to display the search engine view or the commercial advertisement. Alternatively, the search engine view or commercial advertisement may be displayed in a PIP window while the main television programming content remains in the main display area of the screen. Other user display options are possible as well.

Alternatively in accordance with the present invention, a PC system may reside in an automobile and be used to receive programming from an Internet radio station or an Internet television station via a wireless connection to the Internet. The Internet broadcasting station may provide a search engine and/or access to a directory of commercial advertisements via, for example, a voice-activated capability so the user, who may be driving the automobile, does not have to operate a mouse or keyboard to perform searches or to access commercials.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A method to generate revenue for an Internet broadcasting station, said method comprising:
providing programming content via said Internet broadcasting station over the Internet;
providing an Internet search engine as part of said Internet broadcasting station such that a user of said Internet broadcasting station may search for web sites on said Internet without said audio programming content being interrupted; and
paying a provider of said Internet broadcasting station a predetermined monetary amount from a sponsor of said Internet broadcasting station every time a user of said Internet broadcasting station goes to a web site of said sponsor using said Internet search engine.

2. The method according to claim 1, wherein the Internet broadcasting station is an Internet radio station.

3. The method according to claim 1, wherein the Internet broadcasting station is an Internet television station.

4. The method according to claim 1, wherein the Internet broadcasting station is an Internet digital entertainment media station.

5. The method according to claim 1, wherein the programming is accessed through a computer in a vehicle, and the search engine is accessed by voice-activated control.

6. The method according to claim 1, wherein the Internet broadcasting station includes a user interface and includes a directory of audio/video advertisements where a list of such advertisements is displayed to the user via the user interface.

7. The method according to claim 1, wherein the Internet broadcasting station the number of sponsors is intentionally limited such that a paying sponsor receives an enhanced position in the mind of the user.

8. The method according to claim 1, wherein the search engine of the Internet broadcasting station includes filters to make sure the user traffic is qualified.

9. The method according to claim 1, wherein the sponsor will indicate key words on which a bid is submitted, and the Internet broadcasting station will review and compare the desired key search words to the sponsor web site to qualify the sponsor.

10. The method according to claim 1, wherein the search engine or commercial advertisement is displayed is viewed on a display view in a PIP window while the main television programming content remains in the main display area of the screen.

11. A method to generate revenue for an Internet broadcasting station, said method comprising:
providing programming content via said Internet broadcasting station over the Internet;
providing an Internet search engine as part of said Internet broadcasting station such that a user of said Internet broadcasting station may search for web sites on said Internet without said programming content being interrupted; and
paying a provider of said Internet broadcasting station a predetermined monetary amount from a sponsor of said Internet broadcasting station every time a user of said Internet broadcasting station goes to a web site of said sponsor using said Internet search engine.

12. The method of claim 11 wherein said programming content comprises music.

13. A method to generate revenue for an Internet broadcasting station, said method comprising:
setting up an account of monetary funds for each of a plurality of advertisers acting as sponsors of said Internet broadcasting station where each of said advertisers has a web site on the Internet;
having said plurality of advertisers place monetary bids for key search words that a search engine associated with said Internet broadcasting, station would use to find said web sites of said advertisers;
assigning a rank value to each of said plurality of advertisers for each key search word bid on by said plurality of advertisers based on said bids;
paying a provider of said Internet broadcasting station a bid amount from said accounts of said advertisers every time a user of said Internet broadcasting station goes to a web site of said advertisers using said search engine with at least one of said key search words.

14. The method of claim 13 further comprising providing streaming audio programming content to said user from said Internet broadcasting station via said Internet.
